(19) United States
(12) Patent Application Publication
(10) Pub. No.: US 2009/0319063 A1
(43) Pub. Date: Dec. 24, 2009

(54) Splittable portable media player as remote control

(76) Inventor: Yang Pan, (US)

Correspondence Address: Yang Pan, Shimao Riviera Garden, Wei Fang Rd. (W), Lane 1, Block 9, Unit 8A, Shanghai, 200122, CN

(21) Appl. No.: 12/144,568

(22) Filed: Jun. 23, 2008

(51) Int. Cl. G06F 17/00

(52) U.S. Cl. 700/94

(57) ABSTRACT

A novel media delivery system is disclosed with a splittable portable media player, which comprises a user interface unit and a storage unit. The user interface unit includes a user interface and a cache that stores metadata for media files. The storage unit includes a media file system and a signal process unit. The user interface unit remotely controls the storage unit that is connected (wired) with a media delivery unit, which is a stereo system with speakers in one of disclosed embodiments for audio signal. The portable media player is used as a conventional media player when the units are detached. The novel system has the advantages of simplicity over previous arts and, consequently, with lower cost. Furthermore, the wireless data transmission involved in the system consists of the metadata of media files and the security for typically copyrighted media files is superior. A novel method for sharing of media experience with a group of users is also disclosed with the use of portable media players. The method allows multiple users holding a media player with the shared metadata of media files to control the media delivery system to have a shared media experience.

### CROSS-REFERENCE TO RELATED APPLICATIONS

Not applicable.

### BACKGROUND-FIELD OF INVENTION

This invention relates to a portable media player for a media delivery system, specifically to a splittable portable media player, of which one part is used as a remote control and another part as a storage and signal process unit.

### BACKGROUND-DESCRIPTION OF PRIOR ART

A portable media player stores media assets such as songs and video clips, which can be played on the player. Examples of media players are the iPod from Apple, Inc. of Cupertino, Calif., Zen from Creative Technology Ltd, Singapore and the Zune from Microsoft Inc of Redmond, Wash. A media player acquires typically its media assets from a computer with media management applications, such as iTunes software, which is a product from Apple Inc. The portable media players have gained popularity due to its capability to store large number of media assets in a device, which can be put into a user's pocket when he or she is moving around. The large number of media files are organized in a way of automatic hierarchical categorization by metadata as disclosed in a U.S. Pat. No. 6,928,433 to Goodman and Egan (2005). Portable media players with wireless communication capabilities have been disclosed by Fadell, et al in a US patent application 2008/0125031. The use of the wirelessly connected portable media players to form a local network for the peer-to-peer information sharing has also been disclosed by Panabaker et al in a US patent application 2008/0005353, by Haveson et al in 2007/0297426 and by Kirovski and Jain in 2007/0136608.

Although the quality of multimedia playback by computers has improved dramatically in the past, these systems still lag behind typical home entertainment systems in terms fidelity and performance. Therefore, in order to utilize the high quality playback systems and the storage capability of the portable media player, it has become available to have a portable media player that couples to accessory devices such as speakers as in a system disclosed by Hobson et al in a US patent application 2007/0230723 as shown in FIG. 1. A product related to the art has been commercialized in the market by Apple. According to the art, audio output characteristics of a media delivery apparatus can be controlled based on weather a removable player is attached or detached. A separate remote control is used to control the detached portable media player and the media delivery apparatus. The remote control has typically limited functionalities in comparison to the portable media player, which has a well-designed user interface. Furthermore, the additional remote control increases cost of the media delivery system.

Therefore, what is desired is a system that leverages existing devices such as an iPod to provide the remote access and control. In the US patent application 2007/0169115, Ko and Lemay have disclosed an art to use a portable media player to wirelessly access and control a media sever, which is typically a computer that is streaming digital media by way of a wireless interface to a media delivery unit such as speakers in the case of streaming digital audio. The method is performed by binding the portable media player and the media server, wirelessly transmitting a signal from the media player to the media sever, and streaming the digital media data from the media server to a media delivery unit by way of a wireless interface using the received signal. The portable media player with a well-designed user interface has the advantages of easy operation by a user. However, the use of a media server complicates the system and, consequently, increases the cost of the system. Furthermore, the media files are transmitted wirelessly between the media server and the media delivery unit, which imposes security issues for a media asset with the copyright.

Accordingly, it is a purpose of the present invention to provide a new splittable portable media player. One part of the player with its user interface is used as a remote control to wirelessly control another part of the player with its storage and output signal process unit that is coupled to a media delivery unit such as speakers.

It is a further purpose of the present invention to provide a new splittable portable media player, which can be used as a conventional portable media player when the parts are detached.

It is a further purpose of the present invention to provide a novel method for a group of users to share media experience by using the splittable media players.

### SUMMARY OF THE INVENTION

A portable media player comprises two detachable units. One part is with the player's user interface and the battery (the UI unit) and another part is with the player's storage unit and signal process unit (the storage unit), which converts a digital media signal into an analog signal that is further used to drive media delivery unit such as earphones for the portable players.

The UI unit comprises user interface such as a Liquid Crystal Display (LCD) screen and a user interface as a rotational interface used in an iPod from Apple. A battery for the portable media player is also included in the unit to provide power supply when the unit is used as a remote control. The unit further includes a cache to store the catalog of available media items in the storage unit. The media catalog contains media item metadata (song title, author, etc.). The unit further comprises a wireless communication device to communicate with the storage unit when it is detached from the UI unit.

The storage unit comprises a memory unit such as a flash memory and a signal process unit, which converts the digital signal into the analog signal that drives the media delivery unit to deliver a media experience to a user. The storage unit includes one or more connectors or ports that can be used to attach the split storage unit to a media delivery unit. In the prior art by Hobson et al, a method to connect a media player and a media delivery unit has been disclosed in details. The storage unit further comprises a wireless communication device to communicate with the UI unit when the units are detached and when the storage unit is connected to the media delivery unit. The media delivery unit has its power supply that can be used to provide power supply for the storage unit when they are detached.

In one embodiment, a portable media player is split into the UI unit and the storage unit that is attached to the media delivery unit such as speakers. The method of providing wireless remote control of a remote media delivery unit attached with the storage unit is described. The method is carried out by wirelessly receiving a selected metadata of an associated media file from the UI unit by the storage unit. The storage unit will execute the selection and further convert the digital file into a media analog signal through the signal process unit. The analog signal will be processed and then be used to drive the speakers in the case of audio signal to deliver a song to the user.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a diagram of a media system according to one prior art.

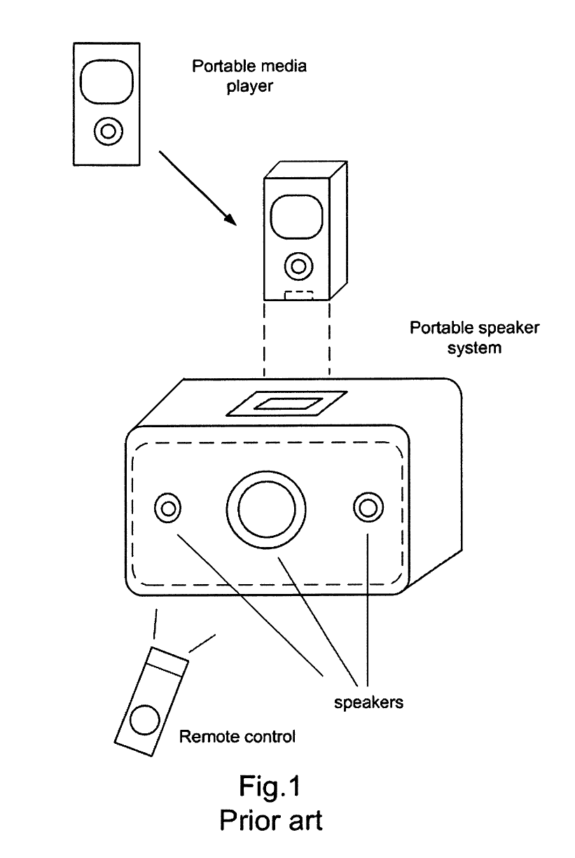

FIG. 2 is a diagram of a media system according to the present invention.

FIG. 3 is a schematic functional block of a conventional portable media player.

FIG. 4 is a schematic functional block of a new splittable portable media player.

FIG. 5 shows a representative wireless connection between an UI unit and a media delivery unit (speakers) attached with a storage unit split from the portable media player.

FIG. 6 shows how the user interface unit from a splittable media player can be used to remotely access the storage unit that is connected with the media delivery unit to affect a media experience.

FIG. 7 shows a flow diagram of remotely accessing the media delivery unit through UI unit and storage unit of a split portable media player with wireless communication means.

FIG. 8 shows another embodiment that the storage unit is a file system and a signal process and wireless communication interface are embedded in the media delivery unit.

FIG. 9 shows a schematic of a group of users sharing a media experience by use of the splittable media players.

### DETAILED DESCRIPTION

References will now be made in detail to a particular embodiment of the invention an example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of invention as defined by the appended claims.

According to one embodiment, the portable media player includes two attached units, which are connected as a unity when it is used as the portable media player. One part is a user interface unit and another is a storage unit. The connection includes an IEEE 1394 compliant type connector. The two units are connected and a latch system can be utilized to ease the connecting and disconnecting actions as those are obvious to the ones familiar with the art. The two units can be detached when the player is intended for a home entertainment system application. In such a circumstance, one part with the user interface and battery (UI unit) is used as remote control. Another part with the storage and signal process (storage unit) is used to connect with a media delivery unit such as speakers through a wired connection including an IEEE 1394 compliant type connector. The data can be transmitted between the UI unit and the storage unit via a wireless link that conforms to various IEEE standards such as IEEE 802.11 (Wi-Fi), IEEE 802.15.1 (Bluetooth) and IEEE 802.15.4 (Zigbee) as well as their amendments.

When a user wishes to listen to a song stored in one's portable media player via external speakers for better quality, one will need to split the player and connect the storage unit with the speaker system. The user can use the UI unit as a remote control, which is essentially the portable media player without media files. However, the metadata associated with the media files are stored in a cache with the UI unit. It is also desirable that a nonvolatile memory such as a flash memory is an addition to the UI unit to store the mentioned metadata in case that the data will not be lost if the power of the unit is switched off. The user will be able to use the user interface of a well-designed portable media player as remote control without notifying the difference from the one using the portable media player with the media files. When a song is selected for play, the metadata associated with the media file will be sent to the storage unit via wireless connection. After receiving the metadata, the storage unit will locate the associated media file and send the processed file to the speakers for play.

The proposed method can be essentially viewed as a media player with a high quality external media delivery unit. The communication between the user interface unit and the storage unit is accomplished through a wireless connection in contrast to prior arts that are accomplished via a data bus system when all units are integrated as a single handheld device.

It should be noted that when the portable media player is not split for the external media delivery unit, it is essentially functioning as a conventional portable media player. The wireless communication connection will be disabled automatically through a software control. The battery associated with the user interface unit will provide power supply for the integrated portable media player.

In another implementation, a portable media player can be designed and manufactured with a detachable memory card or a memory stick. The media delivery unit will have an embedded wireless communication interface and data process means including a processor, a cache and a CODEC, which are needed to receive metadata from the portable media player and to convert the digital media file into an analog signal which can be further used to drive speakers in case of audio media files.

In such an implementation, when a user wishes to listen to a song stored in one's portable media player via external speakers in the media delivery unit for better sound quality, one will need to remove the memory card or the stick storing media files from the portable media player and to plug the card or the stick into a pre-manufactured slot in the media delivery unit to connect with the unit. However, the metadata associated with the media files are stored in a cache with the portable media player. The user will be able to use the user interface of a well-designed portable media player as remote control. When a song is selected for play, the metadata associated with the media file will be sent to the media delivery unit via wireless communication. After receiving the metadata, the processor in the media delivery will locate the associated media file and send the processed media files to the speakers for play.

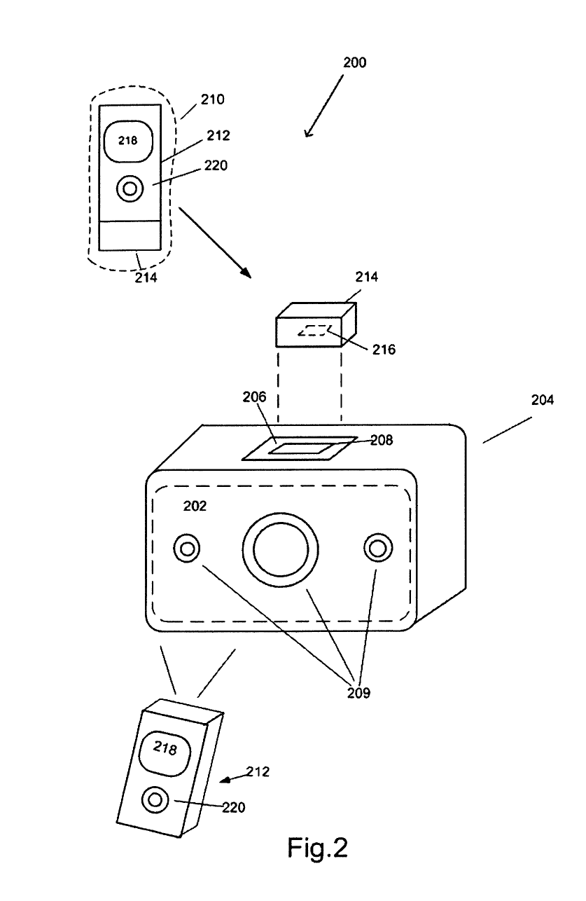

FIG. 2 shows a media delivery system 200 comprising of a media delivery unit 202 with a housing 204, an opening or receptacle 206, a connector 208 and speakers 209, a splittable portable media player 210 comprises two detachable units. One unit is with the player's user interface and the battery (the UI unit 212) and another unit is with the player's storage and output signal process unit (the storage unit 214), which converts digital media data into analog signal that is further used to drive media delivery unit 202 such as speakers for a media experience for a user. The UI unit 212 further comprises user interface such as a LCD screen 218, a rotational user interface 220 as used in the iPod from Apple and a connector (not shown) that connected to the storage unit when the portable media player is used as a single detached media system.

The storage unit 214 comprises a file system and a data process unit. It further comprises one or more connectors or ports 216 that can be used to attach the split storage unit to a media delivery unit such as speakers. In the prior art by Hobson et al, a method to connect a media player and a media delivery unit has been disclosed in detail.

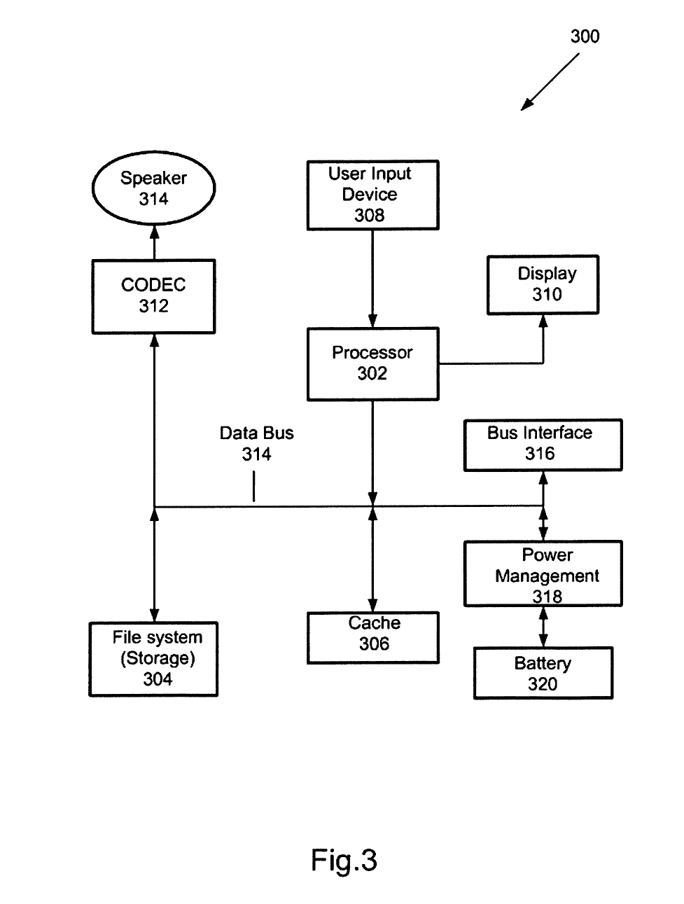

FIG. 3 shows a schematic functional block of a conventional portable media player 300. The media player 300 includes a processor 302 that pertains to a microprocessor or a controller for controlling the overall operation of the media player 300. The media player 300 stores media data pertaining to media assets in a file system 304 and a cache 306. The file system 304 is, typically, a flash memory or a plurality of flash memories or a storage disk or a plurality of disks. The file system 304 typically provides high capacity storage capability for the media player 300. However, since the access time to the file system 304 is relatively slow, the media player 300 can also include a cache 306. The cache 306 is, for example, Random-Access Memory (RAM) provided by semiconductor memory. The relative access time to the cache 306 is substantially shorter than for the file system 304. However, the cache 306 does not have the large storage capacity of the file system 304. Further, the file system 304, when active, consumes more power than does the cache 306. The power consumption is particularly important when the media player 300 is a portable media player that is powered by a battery 320 through power management circuits 318. The media player 300 may also include a RAM and a Read-Only Memory (ROM), which is not shown in the diagram. The ROM can store programs, utilities or processes to be executed in a non-volatile manner. The RAM provides volatile data storage, such as for the cache 306.

The media player 300 also includes a user input device 308 that allows a user of the media player 300 to interact with the media player 300. For example, the user input device 308 can take a variety of forms, such as a button, keypad, dial, etc. Still further, the media player 300 includes a display 310 (screen display) that can be controlled by the processor 302 to display information to the user. A data bus 314 can facilitate data transfer between at least the file system 304, the cache 306, the processor 302, and the CODEC 312. The media player 300 also includes a bus interface 316 that couples to a data link (not shown). The data link allows the media player 300 to couple to a host computer.

The media player 300 serves to store a plurality of media assets (e.g., songs) in the file system 304. When a user desires to have the media player play a particular media item, a list of available media assets is displayed on the display 310. Then, using the user input device 308, a user can select one of the available media assets. The processor 302, upon receiving a selection of a particular media item, supplies the media data (e.g., audio file) for the particular media item to a coder/decoder (CODEC) 312. The CODEC 312 then produces analog output signals for a speaker 314.

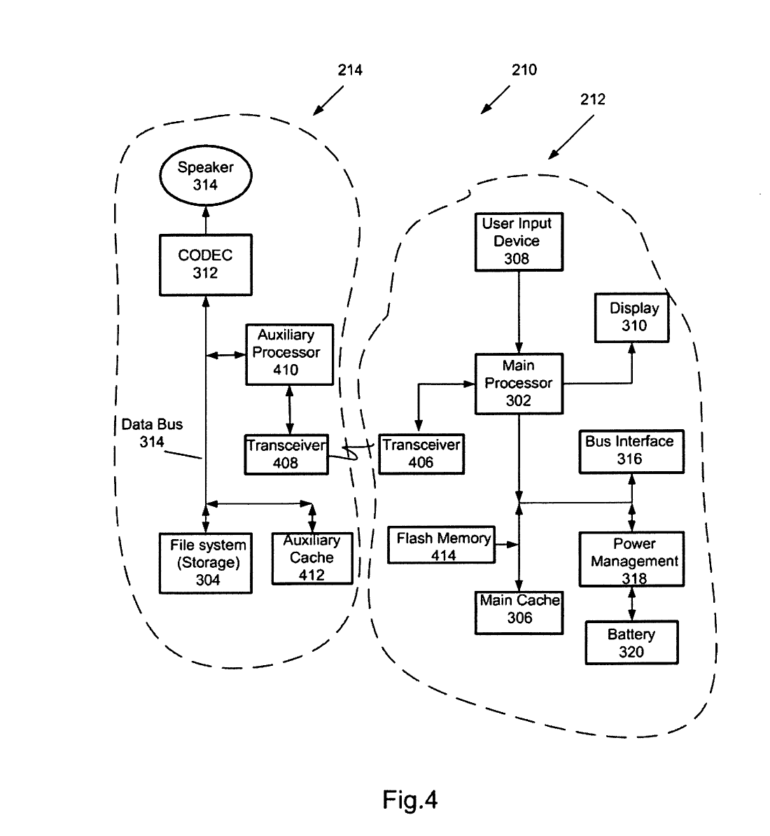

FIG. 4 shows a functional block diagram of a splittable portable media player 210, which comprises a user interface unit (UI unit) 212 and a storage unit 214. In comparison to FIG. 3, where a conventional portable media player is illustrated, FIG. 4 illustrates that a conventional media player is split into two parts with additional function blocks as a transceiver 406 for the UI unit 212 and another transceiver 408 for the storage unit 214. The processor and cache in the UI unit are renamed as main processor and main cache, respectively to differentiate an additional processor called auxiliary processor 410 and auxiliary cache 412 in the storage unit 214. The UI unit may further comprises a non-volatile memory such as a flash memory 414 to store the backup data of the metadata of media files, which enables the media catalog preserves when the power supply of the UI unit is switched off. The storage unit further comprises a transceiver 408 to communicate with the UI unit when they are split and when the storage unit attached to the media delivery unit 202. The media delivery unit has its own power supply and when the storage unit connected to the media delivery, the power supply can be shared.

In one embodiment, the present invention provides a method to use UI unit 212 to remotely control a media delivery unit 202 connected with the storage unit 214. The method is carried out by wirelessly receiving a selected metadata of a media file from the UI unit 212 by the storage unit 214. The storage unit 214 will execute the selection and further converts the associated media file into a media analog signal through the signal process unit. Then the analog signal drives the speakers in the case of audio signal to deliver a song to the user through the speakers.

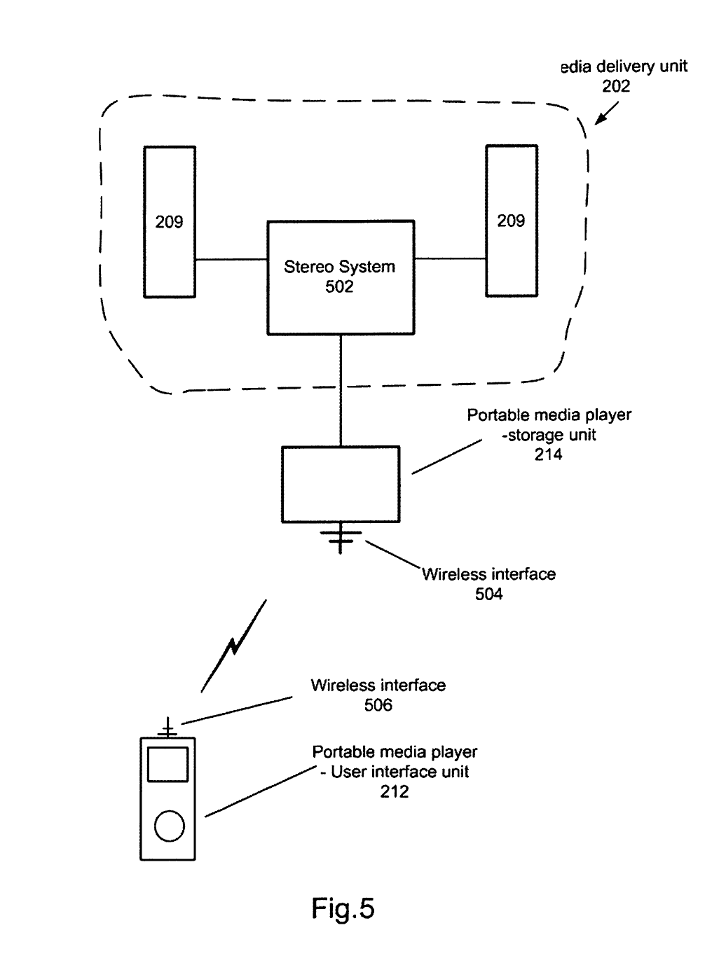

As shown in FIG. 5, in the described embodiment, the storage unit is coupled to the media delivery unit that in this case takes the form of a stereo system 502 having a number of speakers 209. The storage unit 214 in connection with stereo system 502 includes a wireless network interface 504. The UI unit also includes a wireless interface 506. The wireless network interface 504 and 506 support a wireless network. The wireless network can take the form of, for example, a “Wi-Fi” interfaces according to the IEEE 802.11 standard as well as its amendments. Other wireless network standards could also be used, either in alternative to the identified standards or in addition to the identified standards. Such other network standards could include the IEEE 802.15.1 for the Bluetooth standard or IEEE 802.15.4 for the Zigbee standard as well as their amendments. An antenna required for wireless networking is typically included within the housing of the wireless network interface 504 and 506. Such an antenna may take a variety of forms, such as an antenna printed on a standard PCB (printed circuit board). Such antennas are well known to those skilled in the art.

The wireless network supported by the wireless network interface can enable wireless communications between the UI unit 212 and the storage unit 214 when the UI unit 212 described herein is used to select a media item by use of the user interface. As briefly described above, the wireless network interface 504 and 506 have the ability to communicate a user's instruction and enable the storage unit select a media file. Although it is contemplated that audio, video, audio/video, and/or other forms of multimedia may be used with the media system described herein, one exemplary embodiment relates to the sharing of audio data stored on a storage unit with an entertainment device, such as a stereo system.

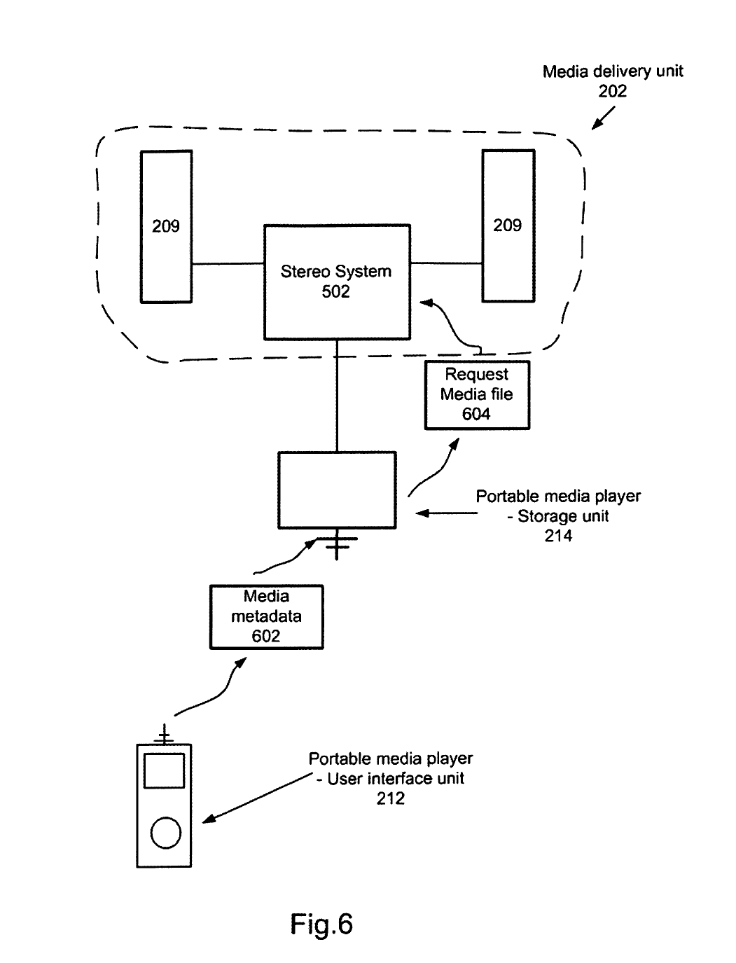

FIG. 6 further illustrates graphically a data flow between the UI unit 212 and the storage unit 214 and the media delivery unit 202 that includes a stereo system 502 and a plurality of speakers 209 in an example of audio media files. Once a user has interacted with the UI unit 212 to, for example, select a new song to be played, the UI unit 212 generates a media metadata 602 that is then forwarded to the storage unit 214. In response to the metadata 602, the storage unit 214 locates the media file 604 and delivers to the stereo 502 and speakers 209 for an audio experience for the user.

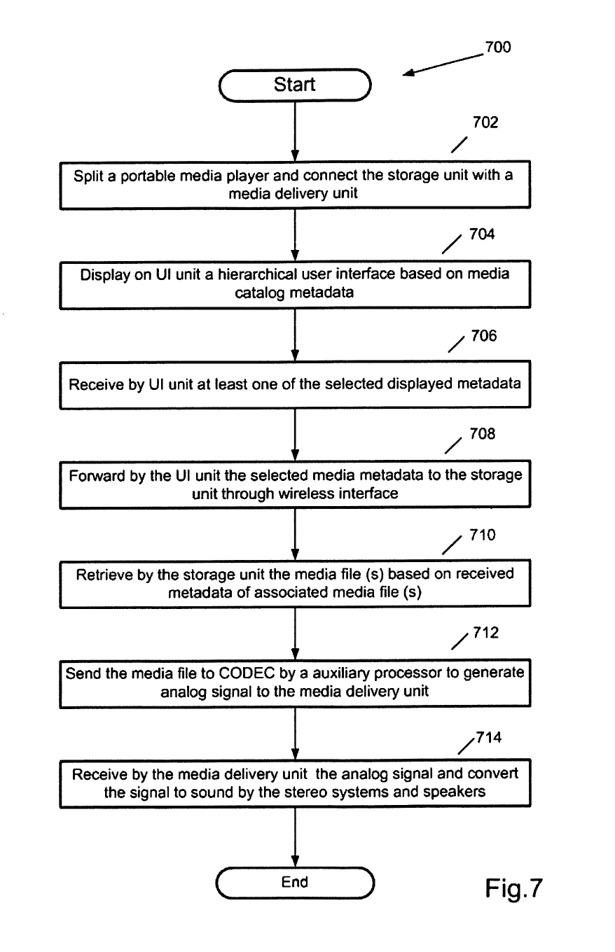

FIG. 7 shows a flow diagram of remotely accessing the media delivery unit through UI unit and storage unit of a split portable media player with wireless communication means. The process 700 begins by a process 702 splitting the portable media player into an UI unit and a storage unit and connecting the storage unit with the media delivery unit. A user operates a hierarchical user interface of the UI unit based on media catalog metadata (704).

In any event, for a given media item (e.g., song), the metadata can include, song title, author, track duration, etc. that corresponds to the requested song and is typically much smaller in size than the associated media file. The user selects at least one of the displayed metadata and the UI unit receives the selection (706). It should be noted that the media file request need only include descriptive information (e.g., metadata) necessary to uniquely identify the selected song by the storage unit. At no time is the song data it transferred from the UI unit to the storage unit, thereby avoiding any copyright infringement based upon protected content. In addition, since the media file request represents a small data transfer (on the order of a few kilobytes), the amount of power required for the generation and forwarding of the media file request from the multimedia player to the media server is substantially reduced over that would be required to send the full media file. In this way, a user can effectively provide remote control of the storage unit and the media delivery unit, e.g., the stereo system, by way without adversely affecting battery life of the UI unit as the remote control.

The UI unit forwards the selected metadata to the storage unit connecting with the media delivery unit via wireless communication means (708). In some cases, the media file being wirelessly forwarded is accompanied by an associated control command to control the stereo system, such as to change the volume, treble, bass, etc. In response to the multimedia metadata request from the UI unit, the storage unit locates the requested media file(s) associated with the metadata. The storage unit then retrieves the media file(s) based on the descriptive information provided by the received metadata (710). The auxiliary processor in the storage unit sends the media file to CODEC to generate appropriate signal to the media delivery unit (712), the media delivery unit receives the signal and converts the electrical signal into high quality sound signal via speakers in case of audio media files (714).

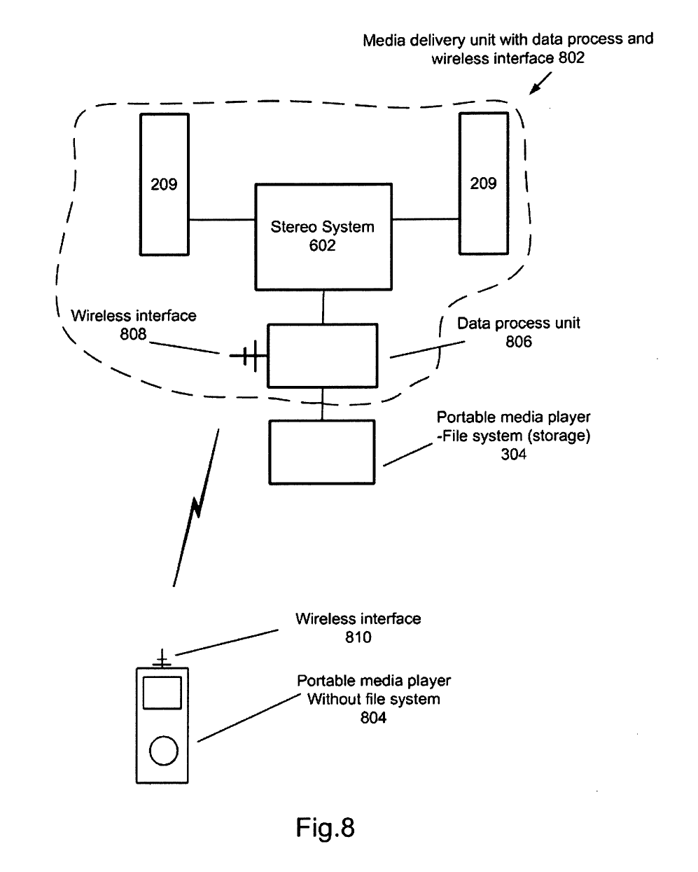

FIG. 8 illustrates another embodiment of the present invention. The media delivery system comprises an expanded media delivery unit 802 and a portable media player 804. The expanded media delivery unit includes an embedded data process unit 806 and a wireless communication interface 808. The portable media player 804 is a media player with a wireless communication interface 810 and a removable file system (storage) 304 that is, for example, a detachable memory card or a detachable memory sticks. The data process unit 806 further includes a processor, a cache and a CODEC, which are needed to receive metadata from the portable media player and to convert the digital media file into an analog signal which can be further used to drive speakers in case of audio media files.

In such an implementation, when a user wishes to listen to a song stored in one's portable media player via external speakers in the media delivery unit for better sound quality, one will need to remove the memory card or the stick 304 storing media files from the portable media player and to plug the card or the stick into a pre-manufactured slot in the media delivery unit 802 to connect with the unit. However, the metadata associated with the media files are stored in a cache with the portable media player 804. The user will be able to use the user interface of a well-designed portable media player as remote control. When a song is selected for play, the metadata associated with the media file will be sent to the media delivery unit via wireless communication 808 and 810. After receiving the metadata, the processor in the media delivery unit will locate the associated media file and send to the stereo system 502 and speakers 209 for play.

We now describe a novel method for sharing media assets by a group of users using portable media players. One of the users has the splittable media player as we described. The other users have either conventional portable media players or the similar splittable media players. All other media payers have a wireless network interface, which conforms to the Bluetooth standard in our preferred embodiment.

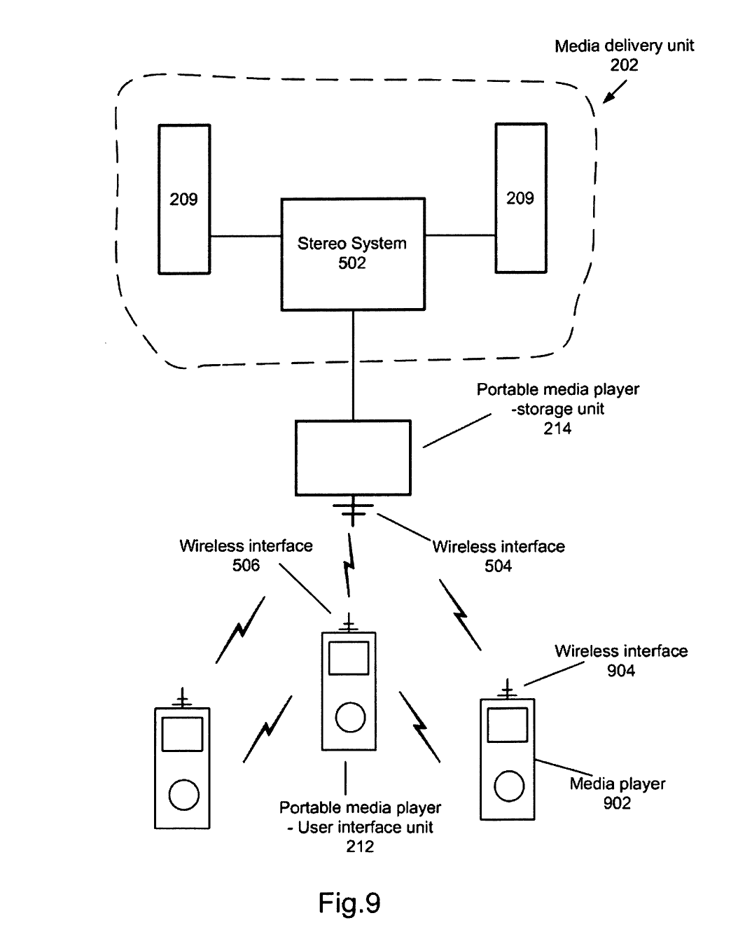

As shown in FIG. 9, one of the splittable media players will be selected as a control device. The user holding the control player will split the media player and connect the storage unit 214 with a media delivery unit 202, which is a stereo system 502 with speakers 209 in our preferred embodiment. A wireless communication will be established between the user interface unit 212 of the control media player and its storage unit 214. The user interface unit 212 will hold the metadata of the media assets associated with media files stored in the file system of the storage unit 214.

When other users with the portable media players 902 that have the wireless network interfaces 904 join the group, a wireless connection between the control device 212 and each of the portable media players 902 will be established. Furthermore, a wireless connection between the other media players 902 and the storage unit 214 will also be established.

The control device 212 will then send the metadata of the media assets to the other media players 902 through the established wireless network. The other users will confirm such transmission and send back an acknowledgement signal to the control device 212, which is used as remote control for the storage unit 214.

At this stage, all media players will have the metadata of the media assets stored in the file system of the storage unit 214. All media players including the user interface unit of the controlling user will have a wireless connection with the storage unit 214. In one of the embodiments, anyone of the users will be able to select a media item from the user interface of one's media player for the metadata associated with the media files stored in the storage unit 214 connecting to the media delivery unit 202. After the selection, the request media metadata will be sent to the storage unit 214. The storage unit 214 will execute the selection and send the associated media file for the processing and eventually delivering the processed analog signal to the speakers 209.

In another embodiment, anyone of non-controlling users will need to send a request signal to the controlling user's device 212 and the selected media metadata can only be sent to the storage unit 214 if an approval signal is received by the requesting user's device 902 from the controlling device 212. The controlling use can accept or deny such a request. If the controlling user decides to accept the request, before he or she sends an approval to the requesting user, the controlling user will need to send a signal to the storage unit 214 to authorize the storage unit to accept the metadata signal from the requesting user. The operation can be programmed and controlled by the processor in the controlling user's user interface unit.

While the invention has been disclosed with respect to a limited number of embodiments, numerous modifications and variations will be appreciated by those skilled in the art. Additionally, although the invention has been described particularly with respect to the audio signal processing, it should be understood that the inventive concepts disclosed herein are also generally applicable to video clip, movies, TV programs, e-book and any other media for entertainment, education and any other applications. It is intended that all such variations and modifications fall with in the scope of the following claims:

1. A media delivery system, comprising:
a splittable media player including a user interface unit, a storage unit and a media delivery unit.

2. The user interface unit as claimed in claim 1, further comprising:
a display device arranged to display a user interface with user selectable items and;
a processor that controls the operation of the said user interface unit and;
a wireless network interface that communicates with said storage unit when said media player is split and;
a battery for providing power to the user interface unit and;
a connector that connects with said storage unit and;
a cache that stores associated metadata of stored media files in said storage unit and;
a non-volatile memory that stores a backup of associated metadata of stored media files in said storage unit.

3. The storage unit as claimed in claim 1, further comprising:
a file storage system for providing means to store media files and;
a processor that controls the operation of said storage unit and;
a wireless network interface that communicates with said user interface unit and;
a cache that stores data with a faster access time than said file storage system and;
a CODEC that converts digital media data into analog signal and;
a connector that connects to said user interface unit and;
a connector that connects to said media delivery unit.

4. The media delivery unit as claimed in claim 1, further comprising:
a stereo system with one or multiple speakers and;
a connector that connects said storage unit and;
a power supply that provides power for said stereo system and said storage unit when said unit is connected to the stereo system.

5. The media delivery unit as claimed in claim 1, further comprising a video display device.

6. The media delivery unit as claimed in claim 1, further comprising a data processing device and a wireless network interface that provides the wireless communication with the user interface unit, wherein the storage unit comprises a media data file system.

7. The data processing unit as claimed in claim 6 comprises a processor, a cache and a CODEC.

8. The splittable media player as claimed in claim 1 provides function as a conventional portable media player when said user interface unit and said storage unit are connected as a unity, wherein the wireless network interfaces are switched off.

9. The user interface unit as claimed in claim 1 provides function as a remote control for said storage unit when said user interface unit and said storage unit are detached.

10. The wireless network interfaces as claimed in claim 2 and claim 3 and claim 6 include IEEE 802.11, IEEE 802.15.1 and IEEE 802.15.4 type of standards as well as their amendments;

11. A method of splitting a media player into a user interface unit and a storage unit to remotely control said storage unit in connection with the a media delivery unit by said user interface unit; comprising:
wirelessly connecting said user interface unit and said storage unit and;
wired connecting said storage unit and said media delivery unit;
transmitting wirelessly a user selected metadata in the user interface unit to the storage unit to retrieve an associated media file;
processing said media file and delivering to the media delivery unit.

12. A method as recited in claim 11, wherein the wirelessly connecting the user interface unit and the storage unit; comprising connecting the user interface unit and the storage unit after the two units are detached.

13. A method as recited in claim 11, further comprising:
displaying a hierarchical user interface on a display screen of the user interface unit including a number of user selectable items;
selecting one of said items by the user interface unit and;
generating a signal transmitting wirelessly to the storage unit.

14. A method as described in claim 13, wherein the selected item is associated with one of the media files.

15. A method as claimed in claim 11, wherein the media file metadata includes a media file title.

16. A method for a group of users to share a media experience by using a media delivery system including a remote control, a media storage and process unit, a media delivery unit and a plurality of media players, comprising:
establishing a wireless connection between the remote control and the storage and processing unit in connection with a media delivery unit by one of the users and;
establishing a wireless connection between the remote control and the said multiple media players from other users and;
establishing a wireless connection between the media players and the storage and process unit and;
transmitting media catalog from the remote control to the media players and;
receiving the media catalog by the media players with metadata associated with media files stored in the storage and process unit and;
selecting one of the media items by any of the users and generating a signal to the storage and process unit.

17. The method claimed in claim 16, further comprising:
the media player sending a request to the said remote control for selecting a media metadata associated with a media file and;
the remote control sending a permission to the storage unit and;
the remote control sending a permission to the media player requesting the selection and;
the media player received said permission and sending the metadata to the storage unit for a media file to be played in the media delivery unit or;
the remote control sending a deny signal to the media player of the requesting user.

18. The claimed remote control in claim 16 is a user interface unit from a splittable media player, comprising:
a display device arranged to display a user interface with user selectable items and;
a processor that controls the operation of the said user interface unit and;
a wireless network interface that communicates with said storage unit when said media player is split and;
a battery for providing power to the interface unit and;
a connector that connects with said storage unit and;
a cache that stores associated metadata of stored media files in said storage unit and;
a non-volatile memory that stores a backup of associated metadata of stored media files in said storage unit.

19. The claimed media storage and process unit in claim 16 is a storage unit from a splittable media player, comprising:
a file storage system for providing means to store media files and;
a processor that controls the operation of said storage unit and;
a wireless network interface that communicates with said user interface unit and;
a cache that stores data with a faster access time than said file storage system and;
a CODEC that converts digital media data into analog signal and;
a connector that connects to said user interface unit and
a connector that connects to said media delivery unit.

20. The claimed media delivery unit in claim 16, comprising:
a stereo system with one or multiple speakers and;
a connector that connects said storage unit and;
a power supply that provides power for said stereo system and said storage unit when said unit is connected to the stereo system.
